(19) United States
(12) Patent Application Publication
(10) Pub. No.: US 2014/0268235 A1
(43) Pub. Date: Sep. 18, 2014

(54) METHODS TO MOBILE PRINTING AND DEVICES AND SYSTEMS THEREOF

(71) Applicant: HITI DIGITAL, INC., New Taipei (TW)

(72) Inventors: Hong-Shun CHIOU, Taipei (TW); Kung-Guan CHEN, Taipei (TW)

(73) Assignee: HITI DIGITAL, INC., New Taipei (TW)

(21) Appl. No.: 14/210,484

(22) Filed: Mar. 14, 2014

Related U.S. Application Data
(63) Continuation-in-part of application No. 13/933,132, filed on Jul. 2, 2013.
(60) Provisional application No. 61/786,542, filed on Mar. 15, 2013.

(51) Int. Cl. G06F 3/12; H04W 8/00

(52) U.S. Cl. CPC G06F 3/1232; G06F 3/1292; H04W 8/005
USPC 358/1.15

(57) ABSTRACT

The present invention discloses methods to mobile printing and devices and systems thereof. The mobile printing of the present invention allows a mobile device to wirelessly discover at least one printing device, wherein such discovery may be done with or without the mobile device knowing any existence and/or capability of the printing device. Also, the mobile device may or may not be connected to a same wireless network as the printing device. The printing device of the present invention supports such printing from mobile devices.

### CROSS-REFERENCE TO RELATED APPLICATIONS

This application is related to and claims priority to U.S. provisional patent application, U.S. Provisional Application No. 61/786,542 filed on Mar. 15, 2013, by the applicants Chien-Hua Huang et al., entitled “Printing devices, detachable flipper module thereof and applications thereof;” and is a continuation-in-part to U.S. non-provisional patent application, Application No. 13/933,132, filed on Jul. 2, 2013, by the applicants Chien-Hua Huang et al., entitled “Printing Devices And Mobile Printing Systems Thereof.”

### FIELD OF THE INVENTION

The present invention relates to methods of mobile printing and devices and systems thereof; and more particularly, the present invention relates to a mobile device capable of wirelessly discovering at least one printing device, wherein such discovery may be done with or without the mobile device knowing any existence and/or capability of the printing device; and more particularly, the present invention relates to a mobile device capable of communicating with a printing device on a same or different wireless network as the printing device; and more particularly, the present invention relates to a printing device supporting such wireless printing from mobile devices.

### BACKGROUND OF THE INVENTION

As today's users get more and more accustomed to using mobile devices to conduct tasks traditionally done on computers, users are less and less tied to a particular physical location. As such, users may travel to a physical location where a mobile device is unaware of what capability any printer has at the physical location. In fact, users may or may not know whether there indeed exists any printing device where the users have traveled.

Therefore, there is a need for methods, devices and systems for a mobile device to discover a printing device even when the mobile device is with and/or is without knowledge of any existence and/or capability of any printing device. Furthermore, there is also a need for a mobile device to communicate with a printing device even when they may or may not be connected on a same wireless network. There also exists a need for a printing device to support mobile devices wirelessly.

### SUMMARY OF THE INVENTION

In light of the drawbacks of the above prior arts, one object of the present invention is to provide methods for a mobile device capable of wirelessly discovering at least one printing device, wherein such discovery may be done with or without the mobile device knowing any existence and/or capability of the printing device.

Additionally, another object of the present invention is to provide a mobile device capable of discovering a printing device on a same or different wireless network as the printing device.

In accordance with an embodiment of the present invention, a mobile device may transmit a signal such as a broadcast, a multicast or unicast with or without the mobile device knowing any existence and/or capability of any printing device. The signal may contain the mobile device's name, IP address or capability. In another embodiment, the broadcast, multicast or unicast may contain a request for any printing device matching at least one capability requirement. When a printing device detects the broadcast, multicast or unicast, the printing device may transmit a response in the form of a broadcast, multicast or unicast. The response may contain the printing device's name, IP address, printing capability requirement and/or other information. The mobile device thus finds the printing device matching the mobile device's capability requirement. The mobile may then connect with the printing device.

In accordance with an embodiment of the present invention, a plurality of printing devices may each transmit a signal such as a broadcast, multicast or unicast. The signal may contain the printing device's name, IP address, printing capability requirement and/or other information. The mobile device may then provide for a selection of printing devices, allowing for connection with any one of the printing devices.

In accordance with yet another embodiment of the present invention, a mobile device may receive a list of one, more than one or all available printing devices. The list may identify at least one capability of each printing device. The mobile device may then selectively connect with a printing device on the list of at least one printing device. In accordance with one embodiment of the present invention, the list may be received via mDNS.

Another object of the present invention is to provide a mobile device used in connection with a printing device to take control of a majority of processing required to output a file received by the printing device so as to minimize the processing power needed by the printing device.

In accordance with the present invention, the mobile device used in connection with a printing device may include a computer readable medium storing computer program instructions to be sent to the printing device to establish a control of the printing device, a transceiver transmitting the instructions to the printing device utilizing one of a plurality of telecommunication network technologies, a processor electrically coupled to the computer readable medium and the transceiver to process a majority of tasks for the printing device once the control is established, and a user interface displaying a selection of options for a user to operate the printing device.

Yet another object of the present invention is to provide a mobile printing system where a first mobile device may be controlled by a second mobile device in such a way that a majority of processing required to output a file received by the first mobile device is performed by the second mobile device so as to minimize the processing power needed by the first mobile device.

In accordance with the present invention, the mobile printing system may include a first mobile device having a communication element capable of communicating with a second mobile device utilizing a plurality of telecommunication network technologies to receive a file sent from the second mobile device to the first mobile device. The first mobile device may have an outputting element to output the file. The second mobile device may have a computer readable medium to store computer program instructions to control a majority of processing required to output the file, wherein the outputting element includes a printing element and an audio outputting element. The printing element is electrically coupled to the communication element to output an image file, whereas the audio outputting element is electrically coupled to the communication element to output an audio file, and wherein the communication element identifies a file type of the file sent from the second mobile device and selectively sends the file to the printing element or the audio outputting element.

In accordance with yet another embodiment of the present invention, a mobile device may take control of a printing device.

Another object of the present invention is to provide a printing device supporting wireless printing from a mobile device, wherein the mobile device may or may not be on a same wireless network as the printing device. In accordance with one embodiment of the present invention, a printing device may be connected to a wireless network, wherein upon connection to the same wireless network, a mobile device may access the printing device.

In accordance with another embodiment of the present invention, a printing device may detect a signal such as a broadcast, a multicast or unicast by a mobile device. The signal may contain the mobile device's name, IP address, printing capability requirement and/or other information. Upon such detection, the printing device may transmit a response such as a broadcast, multicast or unicast. The response may contain the printing device's name, IP address, printing capability requirement and/or other information. The mobile device may then utilize the printing device response as needed by the mobile device.

Certain embodiments of the invention have other aspects in addition to or in place of those mentioned above. The aspects will become apparent to those skilled in the art from reading of the following detailed description when taken with reference to the accompanying drawings.

### BRIEF DESCRIPTION OF DRAWINGS

FIG. 1 is a schematic view of a printing device in accordance with one embodiment of the present invention;

FIG. 2 is a schematic view of a mobile device used in connection with a printing device in accordance with one embodiment of the present invention; and

FIG. 3 is a schematic view of a mobile printing system in accordance with one embodiment of the present invention.

FIG. 4 is a flow diagram of methods in accordance with embodiments of the present invention for a mobile device to discover at least one printing device.

FIG. 5 is another flow diagram of additional methods in accordance with embodiments of the present invention for a mobile device to discover at least one printing device.

### DETAILED DESCRIPTION OF THE INVENTION

The following embodiments are described in sufficient detail to enable those skilled in the art to make and use the invention. It is to be understood that other embodiments would be evident based on the present disclosure, and that changes may be made without departing from the scope of the present invention.

The present invention provides methods of mobile printing and devices and systems thereof. In particular, the present invention provides a mobile device capable of wirelessly connecting with at least one printing device, where such connection may be done with or without the mobile device knowing any existence and/or identity of the printing device. Additionally, in accordance with the present invention, a mobile device may communicate with a printing device on a same or different wireless network as the printing device.

In one embodiment of the present invention, the present invention may utilize the 3^{rd} generation of mobile telecommunications technology (3G). However, those skilled in the art should know that the present invention is not limited to the 3G technology. Instead, any other known communication network technologies, such as 2G, 4G, 4G LTE, Wi-Fi, Bluetooth, infrared (IR), Ethernet, etc., may be utilized in the present invention.

Refer to FIG. 1, which illustrates a schematic view of a printing device in accordance with one embodiment of the present invention. As shown in FIG. 1, in one embodiment of the present invention, the printing device 100 may include a communication element 102. In one embodiment of the present invention, the communication element 102 may be implemented within the printing device 100 as hardware, software, firmware or any combination thereof. As such, the printing device 100 of the present invention is equipped with built-in telecommunication capability. In another embodiment of the present invention, the communication element 102 may be externally connected to the printing device 100, such as via a USB plug. As such, even if the printing device 100 may not be equipped with built-in telecommunication capability, the communication element 102 may be added later on to provide such function. In one embodiment of the present invention, the communication element 102 may be implemented as a circuit, an application program, a communication protocol, or any combination thereof However, it should be noted that the communication element 102 of the present invention is not limited to such implementation.

In accordance with the present invention, the communication element 102 of the present invention may communicate with an external host, such as external host 200, utilizing a plurality of communication network technologies, such as 2G, 3G, 4G, 4G LTE, Wi-Fi, Bluetooth, infrared, Ethernet mentioned above. In one embodiment of the present invention, the external host 200 may be implemented as a mobile device, such as a cell phone, a laptop, a tablet, a digital camera, or any similar device known to those skilled in the art utilizing wireless network technologies, such as 3G or Wi-Fi to communicate with the communication element 102. In another embodiment of the present invention, the external host 200 may be implemented as a wired device, such as a desktop, utilizing the wired Ethernet connection to communicate with the communication element 102. In accordance with the present invention, the external host 200 may upload and download data in high speed utilizing the wireless or wired connection.

In one embodiment of the present invention, the external host 200 may initiate a signal to establish a communication connection with the communication element 102. The communication element 102 may in turn process the signal, acknowledge the initiation, and respond to the external host 200 by confirming the communication connection has been established. The communication element 102 may provide a current status of a particular element within the printing device 100, such as a printing element 106 and an audio outputting element 108, which will be described in details later, to the external host 200 so that the external host 200 may determine whether to send a file to the printing device 100 immediately. Then, the printing device 100 is ready to receive any file the external host 200 is about to send under a peer-to-peer (P2P) structure.

In another embodiment of the present invention, the printing device 100 may communicate with more than one external host utilizing more than one of the plurality of telecommunication network technologies mentioned above. For example, the external host 200 may include a cell phone and a tablet. In such an example, the printing device 100 may communicate with the cell phone using the 3G network. On the other hand, the printing device 100 may communicate with the tablet using Wi-Fi. As such, the printing device 100 may establish a communication connection with the cell phone and the tablet, respectively, so as to output the files received from the cell phone and/or the tablet under a one-to-many network infrastructure.

In accordance with the present invention, the communication element 102 may identify a file type of the file sent from the external host 200. In one example, the external host 200 may send an image file, such as a picture, to the printing device 100. In another example, the external host 200 may send an audio file, such as a music file, to the printing device 100. As such, the communication element 102 of the present invention may identify the file type of the file received from the external host 200, send the file to the corresponding element, and activate the corresponding element to output the file accordingly.

In one embodiment of the present invention, the printing device 100 may include a printing element 104 and an audio outputting element 106. The printing element 104 of the present invention may be electrically coupled to the communication element 102 to output an image file. Additionally, the audio outputting element 106 of the present invention may be electrically coupled to the communication element 102 to output an audio file. As such, when the external host 200 sends an audio file, such as a music file, to the printing device 100, the communication element 102 of the present invention may recognize the file received is a music file, selectively send the music file to the audio outputting element 106, and activate the audio outputting element 106. The audio outputting element 106 may then play the music file.

In another example, the external host 200 may send an image file, such as a picture file, to the printing device 100. The communication element 102 of the present invention may recognize the file received is an image file, selectively send the image file to the printing element 104, and activate the printing element 104. The printing element 104 may then print out the picture. In other words, the communication element 102 of the present invention is equipped with the capability to identify the file type of the file as soon as it is received from the external host 200. As such, less processing is required at the backend when the file is outputted. Additionally, because the communication element 102 of the present invention is equipped with the capability to distinguish between an image file and an audio file, the printing device 100 may be used as a music player to play music files through the audio outputting element 106 without adding more elements or processing requirements to the existing device.

In one embodiment of the present invention, the audio outputting element 106 may be built within the printing device 100, such as an internal speaker. In another embodiment of the present invention, the audio outputting element 106 may be connected to the printing device 100 externally. That is, the audio outputting element 108 may be a separate structure, such as an external speaker, electrically connected to the printing device 100 via a wire to output music files. In one embodiment of the present invention, the external speaker may share the same power source as the printing element 104. In another embodiment of the present invention, the external speaker may have a designated power source.

In accordance with the present invention, the audio outputting element 108 may not only play music files sent from the mobile device 200 individually, but also output a reminder sound after the printing element 104 finishes a print job to remind the user that a picture or a print job is ready for pickup.

In one embodiment of the present invention, the printing device 100 may include a user interface 108. In one embodiment of the present invention, the user interface 108 may be built within the printing device 100 as a screen on a top or side surface of the printing device 100. In another embodiment of the present invention, the user interface 108 may be externally connected to the printing device 100. The user interface 108 of the present invention may provide a screen to display a selection of options for a user to operate the printing device 100, such as to change the print size, the number of prints, etc. The user interface 108 of the present invention may also select a data transmission option to request a file be sent from a remote storage device or to download a file from the remote storage device.

In one embodiment of the present invention, a remote storage device 110 may be provided to store files received from the external host 200. In another embodiment of the present invention, the printing element 100 may retrieve the files from the remote storage device 110 and then output the file. For example, the printing device 100 may retrieve a music file from the remote storage device 110 and play the music file from the audio outputting element 106 accordingly. Or, the printing device 100 may retrieve an image file from the remote storage device 110 and print out the image file from the printing element 104 accordingly. As such, the printing device 100 does not require, a local storage medium to store large amount of images and/or audio files, keeping the size of the printing device as compact as possible.

In one embodiment of the present invention, the remote storage device 110 may communicate with the printing device 100 via a wireless Internet connection. However, it should be understood by those skilled in the art that the remote storage device 110 may also communicate with the printing device 100 via other known communication method, such as 2G, 3G, 4G, 4G LTE, Wi-Fi, Bluetooth, infrared (IR), or Ethernet.

Refer now to FIG. 2, which illustrates a schematic view of a mobile device used in connection with the printing device in accordance with one embodiment of the present invention. As shown in FIG. 2, the mobile device 200 of the present invention may include a computer readable medium 202 to store computer program instructions to control a majority of the processing required to output a file at the printing device 100, such as an image file and/or an audio file.

In one embodiment of the present invention, the computer readable medium 202 may be, for example but not limited to any physically tangible device that operates using magnetic, electronic, electromagnetic, optical, or semiconductor components. In particularly, the computer readable medium 202 may be a memory card, a hard disk, a portable computer diskette, a random access memory, a read-only memory (ROM), or any other physically tangible medium that can contain, store, communicate, or transport a program for use by or in connection with the mobile device 200.

In accordance with the present invention, the computer readable medium 202 may store computer program instructions to be sent to the printing device 100 to establish control of the printing device 100. In one embodiment of the present invention, the computer program instructions stored in the computer readable medium 202 may initiate a signal to establish a communication connection with the printing device 100. After the communication connection is established, the mobile device 200 may receive the current status of the printing element 104 and the audio outputting element 106 as mentioned previously and begin taking control of the printing device 100.

In one embodiment of the present invention, the mobile device 200 may include a processor 206. The processor 206 of the present invention may process the tasks originally to be performed by the printing device 100. In one embodiment of the present invention, the processor 206 may be electrically coupled to the computer readable medium 202 and the transceiver 204 so that once the parameters of the printing element 104 and the audio outputting element 106 are received, the processor 206 may perform the necessary calculation and generate control instructions to be sent to the printing device 100.

In one embodiment of the present invention, the processor 206 may immediately send an instruction to the printing device 100 to print an image file because based on the parameters received from the printing element 104, the printing element 104 is idle. In another embodiment of the present invention, the processor 206 may send an instruction to the printing device to halt a print job because based on the parameters received from the printing element 104, the printing element 104 is busy.

In one embodiment of the present invention, the mobile device 200 may wish to send an image file to the printing device 100. In accordance with the present invention, before a user sends the image file to the printing device 100, the user may first edit the image file from the mobile device 200. For example, the user may wish to add a photo frame, such as a gold or silver color frame, to the image file. In another example, the user may wish to adjust the color saturation of the image file. In accordance with the present invention, the computer readable medium 202 may store computer program instructions to perform such editing at the mobile device 200. As a result, the edited image file may be processed by the processor 206 of the mobile device 200 instead of the printing device 100. When the edited image file is sent to the printing device 100, the communication element 102 of the printing device 100 may simply send the edited image file to the printing element 104 and activate the printing element 104 to output the edited image file.

In another embodiment of the present invention, the mobile device 200 may also send music files to the printing device 100. In such an example, the computer readable medium 202 may store computer program instructions to be sent to the printing device 100 to establish the communication connection. As the communication connection is established, the computer program instructions may send one selected music file or a number of selected music files from its local memory to the printing device 100. In one example, the computer program instructions may randomly send a music file from a local playlist to the printing device 100. When receiving the music files from the mobile device 200, the communication element 102 of the present invention may directly send the file to the audio outputting element 106 and activate the audio outputting element 106 to play the music files. As such, the printing device 100 may be used as a music player without storing the music files locally.

In one embodiment of the present invention, the mobile device 200 may include a transceiver 204. In accordance with the present invention, the computer readable medium 202 is electrically coupled to the transceiver 204 such that the computer program instructions stored in the computer readable medium 202 may be sent to the communication element 102 of the printing device 100. Additionally, the music and/or image files stored in the computer readable medium 202 may also be sent to the communication element 102 of the printing device 100.

In one embodiment of the present invention, the mobile device 200 may include a user interface 208. The user interface 208 of the present invention may display a selection of options for a user to operate the mobile device 200. Additionally, the user interface 208 of the present invention may display a selection of options for the user to operate the printing device 100 once a communication connection is established between the printing device 100 and the mobile device 200. For example, if a user wishes to edit a picture file before printing it out, the user may select a desired photo frame, such as a gold or silver color frame, or change the color saturation of the picture at the mobile device end through the user interface 208. Additionally, the user may also select the printing options, such as picture size, resolution, the number of prints, etc. at the mobile device end through the user interface 208. In other words, once the communication connection is established between the printing device 100 and the mobile device 200, the user interface 208 of the mobile device 200 may display the user menu shown in the user interface 108 of the printing device 100. As such, the mobile device 200 may take control of the printing device 100.

Refer now to FIG. 3, which illustrates a schematic view of a mobile printing system in accordance with one embodiment of the present invention. As shown in FIG. 3, the mobile printing system 300 may include a first mobile device 310 and a second mobile device 320. In one embodiment of the present invention, the first mobile device 310 may be a pocket printer.

In accordance with the present invention, the first mobile device 310 may include a communication element 312. The communication element 312 of the present invention may communicate with the second mobile device 320 utilizing a plurality of telecommunication network technologies. In one embodiment of the present invention, the present method may utilize the 3^{rd} generation of mobile telecommunications technology (3G). However, those skilled in the art should know that the present invention is not limited to the 3G technology. Instead, any other known communication network technologies, such as 2G, 4G, 4G LTE, Wi-Fi, Bluetooth, infrared (IR), Ethernet, etc., may be utilized in the present invention.

For example, the communication element 312 may communicate with the second mobile device 320 via a 3G wireless network. In such an example, the second mobile device 320, such as a cell phone, a desktop, a laptop, a tablet, digital camera, or any similar device known to those skilled in the art, may send a signal to the communication element 312 so as to initiate a communication connection. The communication element 312 may in turn process the signal, acknowledge the initiation, and respond to the second mobile device 320 by confirming the communication connection has been established. The communication element 312 may provide a current status of a particular element within the first mobile device 310, such as a printing element 3142 and an audio outputting element 3144, which will be described in details later, to the second mobile device 320 so that the second mobile device 320 may determine whether to send a file to the first mobile device 310 immediately. Then, the first mobile device 310 is ready to receive any file the second mobile device 320 is about to send under a peer-to-peer (P2P) structure.

In another embodiment of the present invention, the first mobile device 310 may communicate with more than one second mobile device utilizing more than one of the plurality of telecommunication network technologies mentioned above. For example, the second mobile device 320 may include a cell phone and a tablet. In such an example, the first mobile device 310 may communicate with the cell phone using the 3G network. On the other hand, the first mobile device 310 may communicate with the tablet using Wi-Fi. As such, the first mobile device 310 may establish a communication connection with the cell phone and the tablet, respectively, so as to output the files received from the cell phone and/or the tablet under a one-to-many network infrastructure.

In accordance with the present invention, the communication element 312 may identify a file type of the file sent from the second mobile device 320. In one example, the second mobile device 320 may send an image file, such as a picture, to the first mobile device 310. In another example, the second mobile device 320 may send an audio file, such as a music file, to the first mobile device 310. As such, the communication element 312 of the present invention may identify the file type received from the second mobile device 320 and send the file to an outputting element 314.

In one embodiment of the present invention, the outputting element 314 may include a printing element 3142 and an audio outputting element 3144. The printing element 3142 of the present invention may be electrically coupled to the communication element 312 to output an image file. Additionally, the audio outputting element 3144 of the present invention may be electrically coupled to the communication element 102 to output an audio file. As such, when the second mobile device 320 sends an audio file, such as a music file, to the first mobile device 310, the communication element 312 of the present invention may recognize the file received is a music file, selectively send the music file to the audio outputting element 3144, and activate the audio outputting element 3144. The audio outputting element 3144 may then play the music file.

In another example, the second mobile device 320 may send an image file, such as a picture file, to the first mobile device 310. The communication element 312 of the present invention may recognize the file received is an image file, selectively send the image file to the printing element 3142, and activate the printing element 3142. The printing element 3142 may then print out the picture. In other words, the communication element 312 of the present invention is equipped with the capability to identify the file type of the file as soon as it is received from the second mobile device 320. As such, less processing is required at the backend when the file is outputted. Additionally, because the communication element 312 of the present invention is equipped with the capability to distinguish between an image file and an audio file, the first mobile device 310 may be used as a music player to play music files through the audio outputting element 3144 without adding more elements or processing requirements to the existing device.

In one embodiment of the present invention, the audio outputting element 3144 may be built within the first mobile device 310, such as an internal speaker. In another embodiment of the present invention, the audio outputting element 3144 may be connected to the first mobile device 310 externally. That is, the audio outputting element 3144 may be a separate structure, such as an external speaker, electrically connected to the first mobile device 310 via a wire to output music files. In one embodiment of the present invention, the external speaker may share the same power source as the printing element 3142. In another embodiment of the present invention, the external speaker may have a designated power source.

In accordance with the present invention, the audio outputting element 3144 may not only play music files sent from the second mobile device 320 individually, but also output a reminder sound after the printing element 3142 finishes a print job to remind the user that a picture or a print job is ready for pickup.

In one embodiment of the present invention, the first mobile device 310 may include a user interface 318. In one embodiment of the present invention, the user interface 318 may be built within the first mobile device 310 as a screen on a top or side surface of the first mobile device 310. In another embodiment of the present invention, the user interface 318 may be externally connected to the first mobile device 310. The user interface 318 of the present invention may provide a screen to display a selection of options a user to operate the first mobile device 310, such as to change the print size, the number of prints, etc. The user interface 318 of the present invention may also select a data transmission option to request a file be sent from a remote storage device or to download a file from the remote storage device.

In one embodiment of the present invention, a remote storage device 330 may be provided to store files received from the second mobile device 320. In another embodiment of the present invention, the printing element 3142 may retrieve the files from the remote storage device 330 and then output the file. For example, the first mobile device 310 may retrieve a music file from the remote storage device 330 and play the music file from the audio outputting element 3144 accordingly. Or, the first mobile device 310 may retrieve an image file from the remote storage device 330 and print out the image file from the printing element 3142 accordingly. As such, the first mobile device 310 does not require a local storage medium to store large amount of images and/or audio files keeping the size of the printing device as compact as possible.

In one embodiment of the present invention, the remote storage device 330 may communicate with the first mobile device 310 via a wireless Internet connection. However, it should be understood by those skilled in the art that the remote storage device 330 may also communicate with the first mobile device 310 via any other known communication method, such as 2G, 3G, 4G, 4G LTE, Wi-Fi, Bluetooth, or infrared (IR).

In accordance with the present invention, the second mobile device 320 of the present invention may include a computer readable medium 322 to store computer program instructions to control a majority of the processing required to output a file at the first mobile device 310, such as an image file and/or an audio file.

In one embodiment of the present invention, the computer readable medium 322 may be, for example but not limited to any physically tangible device that operates using magnetic, electronic, electromagnetic, optical, or semiconductor components. In particularly, the computer readable medium 322 may be a memory card, a hard disk, a portable computer diskette, a random access memory, a read-only memory (ROM), or any other physically tangible medium that can contain, store, communicate, or transport a program for use by or in connection with the second mobile device 320.

In accordance with the present invention, the computer readable medium 322 may store computer program instructions to be sent to the first mobile device 310 to establish control of the first mobile device 310. In one embodiment of the present invention, the computer program instructions stored in the computer readable medium 322 may initiate a signal to establish a communication connection with the first mobile device 310. After the communication connection is established, the second mobile device 320 may receive the current status of the printing element 3142 and the audio outputting element 3144 as mentioned previously and begin taking control of the first mobile device 310.

In one embodiment of the present invention, the second mobile device 320 may include a processor 326. The processor 326 of the present invention may process the tasks originally to be performed by the first mobile device 310. In one embodiment of the present invention, the processor 326 may be electrically coupled to the computer readable medium 322 and the transceiver 324 so that once the parameters of the printing element 3142 and the audio outputting element 3144 are received, the processor 326 may perform the necessary calculation and generate control instructions to be sent to the first mobile device 300.

In one embodiment of the present invention, the processor 326 may immediately send an instruction to the first mobile device 310 to print an image file because based on the parameters received from the printing element 3142, the printing element 3142 is idle. In another embodiment of the present invention, the processor 326 may send an instruction to the printing device to halt a print job because based on the parameters received from the printing element 3142, the printing element 3142 is busy.

In one embodiment of the present invention, the second mobile device 320 may wish to send an image file to the first mobile device 310. In accordance with the present invention, before a user sends the image file to the first mobile device 310, the user may first edit the image file from the second mobile device 320. For example, the user may wish to add a photo frame, such as a gold or silver color frame, to the image file. In another example, the user may wish to adjust the color saturation of the image file. In accordance with the present invention, the computer readable medium 322 may store computer program instructions to perform such editing at the second mobile device 320. As a result, the edited image file may be processed by the processor 326 of the second mobile device 320 instead of the first mobile device 310. When the edited image file is sent to the first mobile device 310, the communication element 312 of the first mobile device 310 may simply send the edited image file to the printing element 3142 and activate the printing element 3142 to output the edited image file.

In another embodiment of the present invention, the second mobile device 320 may also send music files to the first mobile device 310. In such an example, the computer readable medium 322 may store computer program instructions to be sent to the first mobile device 310 to establish the communication connection. As the communication connection is established, the computer program instructions may send one selected music file or a number of selected music files from its local memory to the first mobile device 310. In one example, the computer program instructions may randomly send a music file from a local playlist to the first mobile device 310. When receiving the music files from the second mobile device 320, the communication element 312 of the present invention may directly send the file to the audio outputting element 3144 and activate the audio outputting element 3144 to play the music files. As such, the first mobile device 310 may be used as a music player without storing the music files locally.

In one embodiment of the present invention, the second mobile device 320 may include a transceiver 324. In accordance with the present invention, the computer readable medium 322 is electrically coupled to the transceiver 324 such that the computer program instructions stored in the computer readable medium 322 may be sent to the communication element 312 of the first mobile device 310. Additionally, the music and/or image files stored in the computer readable medium 322 may also be sent to the communication element 312 of the first mobile device 310.

In one embodiment of the present invention, the second mobile device 320 may include a user interface 328. The user interface 328 of the present invention may display a selection of options for a user to operate the second mobile device 320. Additionally, the user interface 328 of the present invention may display a selection of options for the user to operate the first mobile device 310 once a communication connection is established between the first and second devices 310, 320. For example, if a user wishes to edit a picture file before printing it out, the user may select a desired photo frame, such as a gold or silver color frame, or change the color saturation of the picture at the second mobile device end through the user interface 328. Additionally, the user may also select the printing options, such as picture size, the number of copies to print out, etc. at the second mobile device end through the user interface 328. In other words, once the communication connection is established between the first and second mobile devices 310, 320, the user interface 328 of the second mobile device 320 may display the user menu shown in the user interface 318 of the first mobile device 310. As such, the second mobile device 320 may take control of the first mobile device 310.

Referring now to FIG. 4, a flow diagram illustrating various methods in accordance with embodiments of the present invention for a mobile device to discover at least one printing device is shown. In accordance with the present invention, a mobile device may discover at least one printing device, wherein such discovery may be done with or without the mobile device knowing any existence and/or capability of the printing device. Additionally, in accordance with the present invention, a mobile device may communicate with a printing device on a same or different wireless network as the printing device.

According to one embodiment of the present invention, a mobile device and a printing device under different networks may communicate via possible technologies including unicast DNS and NAT. Additionally, a mobile device and a printing device under the same network may communicate with or without a same access point (AP) within a same local network, utilizing possible technologies such as broadcast, multicast and unicast. For illustrative purposes, FIG. 4 and FIG. 5 will use broadcast, multicast and unicast signals as exemplary embodiments of the present invention.

Turning now to FIG. 4, in accordance to an embodiment of the present invention, when a mobile device desires to discover a printing device, as illustrated in step 410, the mobile device may first determine whether the mobile device knows of any existence of any printing device. Additionally, in accordance with yet another embodiment of the present invention, in step 410, the mobile device may determine whether mobile device knows of any existence of any printing device with any particular capability matching the mobile device's needs. If the mobile device is aware of the existence and/or capability of a printing device, the mobile device may determine whether the printing device is connected to a wireless network such as WiFi or Access Point (AP) in step 420. If yes, the mobile device may discover the printing device via the wireless network or any identifier of the printing device, including but not limited to SSID and IP address, as illustrated in step 480.

Alternatively, in accordance with another embodiment of the present invention, if a mobile device is unaware of any existence and/or capability of any printing device, the mobile device may still discover a printing device by searching for the printing device. Specifically, in step 430, the mobile device may determine whether it is aware of any wireless network such as WiFi or Access Point (AP). If yes, the mobile device may search on the wireless network, for example, by mDNS or other means as shown in step 440, to identify any and/or all printing devices on the wireless network. The identification may additionally include capability of the printing devices, in accordance to another embodiment of the present invention. Through the identification, the mobile device may then discover the printing device as illustrated in step 480.

In accordance with one embodiment of the present invention, mDNS may provide a list of one, more than one or all available printing devices on the wireless network for the mobile device to access. In accordance with another embodiment of the present invention, the list may include capability of the printing devices.

In accordance with yet another embodiment of the present invention, if a mobile device is unaware of any existence and/or capability of any printing device and is also unaware of any existence and/or identity of any wireless network, the mobile device may still discover a printing device by searching for the printing device. Specifically, in step 450, the mobile device may send a signal such as a broadcast, multicast or unicast in its search for a printing device. In accordance to one embodiment of the present invention, the mobile device may broadcast and/or multicast a signal which allows for one or more responses from one or more printing devices. The broadcast and/or multicast may identify the mobile device, such as the IP address of the mobile device. In an alternative embodiment, the broadcast and/or multicast may include at least one capability desired by the mobile device.

In accordance with one embodiment of the present invention, when a printing device detects the mobile device signal such as the broadcast, multicast or unicast, the printing device may transmit a response signal. The response signal may also be a broadcast, multicast or unicast. In a preferred embodiment, a unicast response is sent. The unicast may contain an identifier of the printing device such as the printing device's name and/or IP address. In an alternative embodiment, the unicast may contain one, some or all of the capabilities of the printing device.

Alternatively, in yet another embodiment of the present invention, a printing device may transmit a printing device signal such as a broadcast, multicast or unicast signal without any prompt from any mobile device. In accordance with one embodiment of the present invention, the printing device signal may contain one, some or all of the capabilities of the printing device.

Turning again to FIG. 4, in accordance to one embodiment of the present invention, if a mobile device receives a printing signal from a printing device, the mobile device may then discover the printing device via the printing device signal in step 480.

In an alternative embodiment of the present invention, a plurality of printing devices may each transmit a printing device signal such as a broadcast, multicast or unicast. Again, in a preferred embodiment, a unicast is sent, and the unicast may contain the printing device's name, IP address, printing capability and/or other information. The mobile device may then provide for a selection of printing devices, allowing for connection with any one of the printing devices via the printing device signals.

If no unicast response or any printing device signal is detected in step 460, a manual connection from a mobile device to a printing device may also be possible in accordance with one embodiment of the present invention. Specifically, a mobile device may physically locate an identifier of a printing device and connect to the printing device via the physical identifier in step 470.

FIG. 5 is another flow diagram of additional methods in accordance with embodiments of the present invention for a mobile device to discover at least one printing device. In an alternative embodiment, a mobile device may first detect whether any printing device signal exists before broadcasting, multicasting and/or unicasting the mobile device's signal as illustrated in step 550.

In yet an alternative embodiment, a mobile device may first determine the existence and/or identity of any wireless network before determining the existence and/or capability of any printing device.

In another preferred embodiment, upon discovery of a printing device, a mobile device may program and/or re-program the printing device to designate a wireless network, SSID, IP address, identifying signal, and/or any other identifier of the printing device for ease of future access to the printing device.

While the invention has been described in conjunction with exemplary preferred embodiments, it is to be understood that many alternatives, modifications, variations as well as orders of steps will be apparent to those skilled in the art in light of the foregoing description. Accordingly, it is intended to embrace all such alternatives, modifications, variations, and orders of steps that fall within the scope of the included claims. The scope of the claims, therefore, should be accorded the broadest interpretation so as to encompass all such modifications and similar arrangements. All matters set forth herein or shown in the accompanying drawings are to be interpreted in an illustrative and non-limiting sense.

What is claimed is:

1. A method for a mobile device to discover at least one printing device, said method comprising:
a mobile device sending a mobile device signal for at least one requested printing device capability;
at least one printing device receiving said mobile device signal;
said printing device comparing capabilities of said printing device with said requested printing device capability.

2. The method of claim 1, wherein at least one printing device with a capability of said printing device matching said requested printing device capability and said matched printing device responding to said mobile device signal with a printing device signal.

3. This method of claim 1, wherein said mobile device signal is a broadcast, multicast or unicast.

4. This method of claim 2, wherein said printing device signal comprises at least said printing device's name, IP address or capability.

5. The method of claim 2, wherein said printing device signal is a multicast or unicast.

6. The method of claim 2 further comprising:
more than one printing devices responding to said mobile device signal with more than one printing device signals;
said mobile device receiving said more than one printing device signals; and
said mobile device providing for a selection of printing devices, allowing for connecting to said more than one printing devices utilizing said printing device signals.

7. The method of claim 1, wherein said mobile device connecting to said printing device in order for said mobile device to take control of a majority of processing required to output a file received by the printing device so as to minimize the processing power needed by the printing device.

8. A method for a mobile device to discover at least one printing device, said method comprising:
at least one printing device sending a printing device signal identifying at least one capability of said printing device;
a mobile device detecting said printing device signal; and
said mobile device comparing said capability of said printing device with a need of said mobile device.

9. The method of claim 8, wherein said printing device signal comprises said printing device's name, IP address or capability.

10. The method of claim 8, wherein said printing device signal is a multicast or unicast.

11. The method of claim 8, further comprising:
more than one printing devices sending printing device signals identifying at least one capability of said printing devices;
said mobile device detecting said more than one printing device signals; and
said mobile device providing for a selection of printing devices, allowing for connecting to said more than one printing devices utilizing said printing device signals.

12. The method of claim 8, wherein said printing device signal is sent via mDNS.

13. The method of claim 8, wherein said mobile device connecting to said printing device in order for said mobile device to take control of a majority of processing required to output a file received by the printing device so as to minimize the processing power needed by the printing device.

14. A mobile device used in search of at least one printing device, said mobile device comprising:
a computer readable medium storing computer program instructions to be sent to said at least one printing device to establish a control of said printing device;
a transceiver electrically coupled to said computer readable medium to transmit said instructions to said printing device utilizing one of a plurality of telecommunication network technologies;
a processor electrically coupled to said computer readable medium and said transceiver to process a majority of tasks for said printing device once said control is established; and
a user interface displaying a selection of options for a user to operate said printing device,
wherein said mobile device sends a mobile device signal for at least one requested printing device capability;
at least one printing device receives said mobile device signal;
said printing device compares capabilities of said printing device with said requested printing device capability.

15. The mobile device of claim 14, wherein at least one printing device with a capability of said printing device matches said requested printing device capability and said matched printing device responds to said mobile device signal with a printing device signal.

16. A mobile device used in search of at least one printing device, said mobile device comprising:
a computer readable medium storing computer program instructions to be sent to said at least one printing device to establish a control of said printing device;
a transceiver electrically coupled to said computer readable medium to transmit said instructions to said printing device utilizing one of a plurality of telecommunication network technologies;
a processor electrically coupled to said computer readable medium and said transceiver to process a majority of tasks for said printing device once said control is established; and
a user interface displaying a selection of options for a user to operate said printing device,
wherein said at least one printing device sends a printing device signal identifying at least one capability of said printing device; said mobile device detects said printing device signal; and
said mobile device compares said capability of said printing device with a need of said mobile device.

17. The mobile device of claim 16, wherein said printing device signal comprises said printing device's name, IP address or capability.

18. A printing device, comprising:
a communication element capable of communicating with a mobile device utilizing a plurality of telecommunication network technologies to receive a file sent from said mobile device to the printing device; and
an outputting element to output said file;
wherein said mobile device having a computer readable medium storing computer program instructions to control a majority of processing required to output said file;
said printing device sends a printing device signal identifying at least one capability of said printing device;
said mobile device detects said printing device signal; and
said mobile device compares said capability of said printing device with a need of said mobile device.

19. The printing device of claim 18, wherein said printing device broadcast comprises at least said printing device's name, IP address or capability.

20. A mobile printing system, said system comprising:
a first mobile device, said first mobile device having a communication element capable of communicating with a second mobile device utilizing a plurality of telecommunication network technologies to receive a file sent from
said second mobile device to said first mobile device, and said first mobile device having an outputting element to output said file;
said second mobile device having a computer readable medium storing computer program instructions to control a majority of processing required to output said file,
wherein said first mobile device sends a first mobile device signal identifying at least one capability of said first mobile device;
said second mobile device detects said first mobile device signal; and
said second mobile device compares said capability of said first mobile device with a need of said second mobile device.
